(19) United States
(12) Patent Application Publication
(10) Pub. No.: US 2018/0266547 A1
(43) Pub. Date: Sep. 20, 2018

(54) AUTOMATIC TRANSMISSION CONTROLLER

(71) Applicant: TOYOTA JIDOSHA KABUSHIKI KAISHA, Toyota-shi ,Aichi (JP)

(72) Inventors: Keisuke OTA, Toyota-shi (JP); Yoshio HASEGAWA, Chiryu-shi (JP)

(73) Assignee: TOYOTA JIDOSHA KABUSHIKI KAISHA, Toyota-shi, Aichi (JP)

(21) Appl. No.: 15/741,425

(22) PCT Filed: Aug. 22, 2016
(86) PCT No.: PCT/JP2016/074419

§ 371 Date: Jan. 2, 2018

(30) Foreign Application Priority Data
Aug. 24, 2015 (JP) 2015-165063

(51) Int. Cl. F16H 61/04

(52) U.S. Cl. CPC F16H 61/04; F16H 2059/147; F16H 2061/0444

(57) ABSTRACT

An automatic transmission controller is provided, which is capable of reducing occurrence of a shift shock while improving responsiveness of a driving force. An ECU is configured to calculate a target shift time based on an input torque that is input to the automatic transmission when a gear stage is shifted from a current gear stage to a target gear stage spaced two or more stages apart from the current gear stage. The ECU is also configured to: shift the gear stage to an intermediate gear stage between the current gear stage and the target gear stage when the target shift time is not less than a predetermined value; and to shift the gear stage directly to the target gear stage when the target shift time is less than the predetermined value.

### TECHNICAL FIELD

The present invention relates to automatic transmission controllers.

### BACKGROUND ART

Conventionally, an automatic transmission controller is known, which controls an automatic transmission to selectively engage a plurality of friction engaging elements and thus to establish multiple gear stages (see, for example, Patent Document 1).

In the automatic transmission controller according to Patent Document 1, when downshift is performed by skip shift from the fifth gear stage to the second gear stage, at first the downshift from the fifth gear stage to the third gear stage is performed, and thereafter the downshift from the third gear stage to the second gear stage is performed.

### PRIOR ART DOCUMENT

Patent Document

[Patent Document 1] JP 1108-261316 A

### SUMMARY OF THE INVENTION

### Problems to be Solved by the Invention

However, when the above-described conventional automatic transmission controller shifts the gear stage from the current gear stage to a target gear stage via an intermediate gear stage in a short time, each shift time (i.e. the shift time for shifting the current gear stage to the intermediate gear stage, and the shift time for shifting the intermediate gear stage to the target gear stage) is also shortened, which may cause shift shock.

The present invention was made in order to resolve the above problems, and an object of the present invention is to provide an automatic transmission controller capable of improving responsiveness of the driving force while reducing occurrence of the shift shock.

### Means for Solving the Problem

An automatic transmission controller of the present invention is to be applied to an automatic transmission configured to selectively engage a plurality of friction engaging elements and thus to establish multiple gear stages. The automatic transmission controller is configured to calculate a target shift time based on an input torque that is input to the automatic transmission when a gear stage is shifted from a current gear stage to a target gear stage spaced two or more stages apart from the current gear stage. The automatic transmission controller is also configured to: shift the gear stage to an intermediate gear stage between the current gear stage and the target gear stage when the target shift time is not less than a predetermined value; and shift the gear stage directly to the target gear stage when the target shift time is less than the predetermined value.

With the above-described configuration, it is possible to reduce occurrence of the shift shock by directly shifting the gear stage to the target gear stage when the target shift time is less than the predetermined value. Also, it is possible to improve responsiveness of the driving force by shifting the gear stage to the intermediate gear stage when the target shift time is not less than the predetermined value.

### Effects of the Invention

With the automatic transmission controller of the present invention, it is possible to improve responsiveness of the driving force while reducing occurrence of the shift shock.

### BRIEF DESCRIPTION OF THE DRAWINGS

FIG. 1 is a diagram showing a schematic configuration of a vehicle including an ECU according to an embodiment of the present invention.

FIG. 2 is a table indicating respective engaged states among first through fourth clutches and first and second brakes at every gear stages in the automatic transmission of FIG. 1.

FIG. 3 is a block diagram showing the ECU of FIG. 1.

FIG. 4 is a flowchart indicating shift control in the vehicle of FIG. 1.

### MEANS FOR CARRYING OUT THE INVENTION

Hereinafter, a description will be given on an embodiment of the present invention with reference to the drawings.

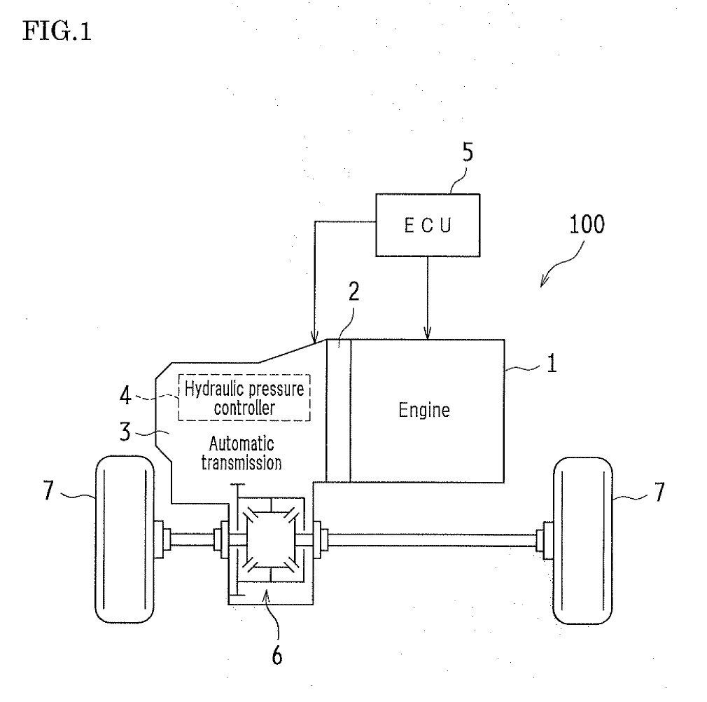

First, a description will be given on a vehicle 100 including an ECU 5 according to the embodiment of the present invention with reference to FIGS. 1 to 3.

As shown in FIG. 1, the vehicle 100 includes: an engine 1; a torque converter 2; an automatic transmission 3; a hydraulic pressure controller 4; and the ECU 5. The vehicle 100 is, for example, an FF (front engine/front wheel drive) vehicle, in which output from the engine 1 is transmitted to a differential device 6 via the torque converter 2 and the automatic transmission 3 so as to be distributed to left and right drive wheels (front wheels) 7.

### —Engine—

The engine (internal combustion engine) 1 is a driving force source for vehicle traveling such as a multi-cylinder gasoline engine. The engine 1 is capable of controlling the operating state using a throttle valve opening degree (intake air amount) of a throttle valve, a fuel injection amount, an ignition timing, and the like. A crankshaft, which is an output shaft of the engine 1, is connected to the torque converter 2.

### —Torque Converter—

The torque converter 2 includes: an input side pump impeller; an output side turbine runner; a stator that realizes a torque amplification function; and a lock-up clutch that directly connects the pump impeller to the turbine runner. The pump impeller is coupled to the crankshaft of the engine 1, and the turbine runner is coupled to an input shaft of the automatic transmission 3 via a turbine shaft.

### —Automatic Transmission—

The automatic transmission 3 is a multistage automatic transmission that includes a plurality of friction engaging elements and a planetary gear device. The automatic transmission 3 is capable of selectively establishing multiple gear stages by engaging, selectively, the plurality of friction engaging elements. An output shaft of the automatic transmission 3 is coupled to the drive wheels 7 via the differential device 6.

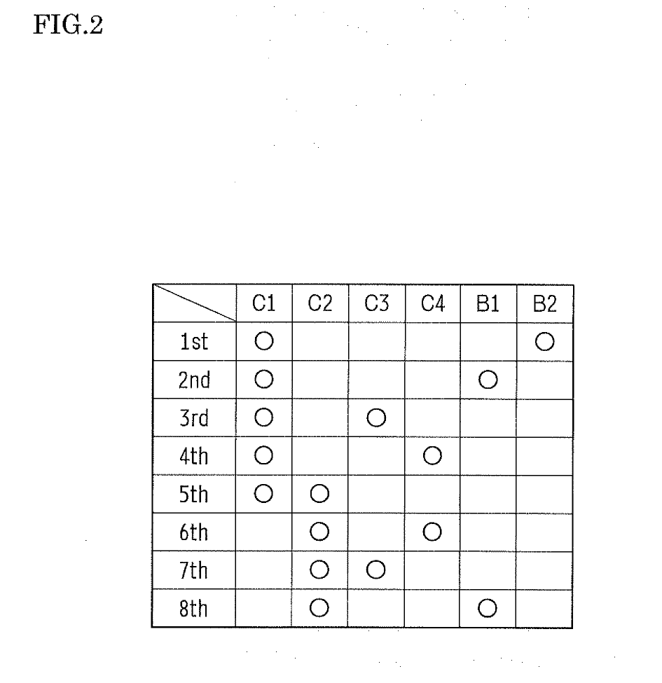

For example, as shown in FIG. 2, the automatic transmission 3 includes, as the friction engaging elements, a first clutch C1 to a fourth clutch C4, a first brake B1, and a second brake B2. In this example, a first gear stage (1^{st}) having the highest gear ratio is established by engaging the first clutch C1 with the second brake B2. A second gear stage (2^{nd}) is established by engaging the first clutch C1 with the first brake B1. A third gear stage (3^{rd}) is established by engaging the first clutch C1 with the third clutch C3. A fourth gear stage (4^{th}) is established by engaging the first clutch C1 with the fourth clutch C4. A fifth gear stage (5^{th}) is established by engaging the first clutch C1 with the second clutch C2. A sixth gear stage (6^{th}) is established by engaging the second clutch C2 with the fourth clutch C4. A seventh gear stage (7^{th}) is established by engaging the second clutch C2 with the third clutch C3. An eighth gear stage (8^{th}) is established by engaging the second clutch C2 with the first brake B1.

### —Hydraulic Pressure Controller—

The hydraulic pressure controller 4 is provided to control the state of the friction engaging elements of the automatic transmission 3 (i.e. engaged state or released state). The hydraulic pressure controller 4 also has a function to control the lock-up clutch of the torque converter 2.

### —ECU—

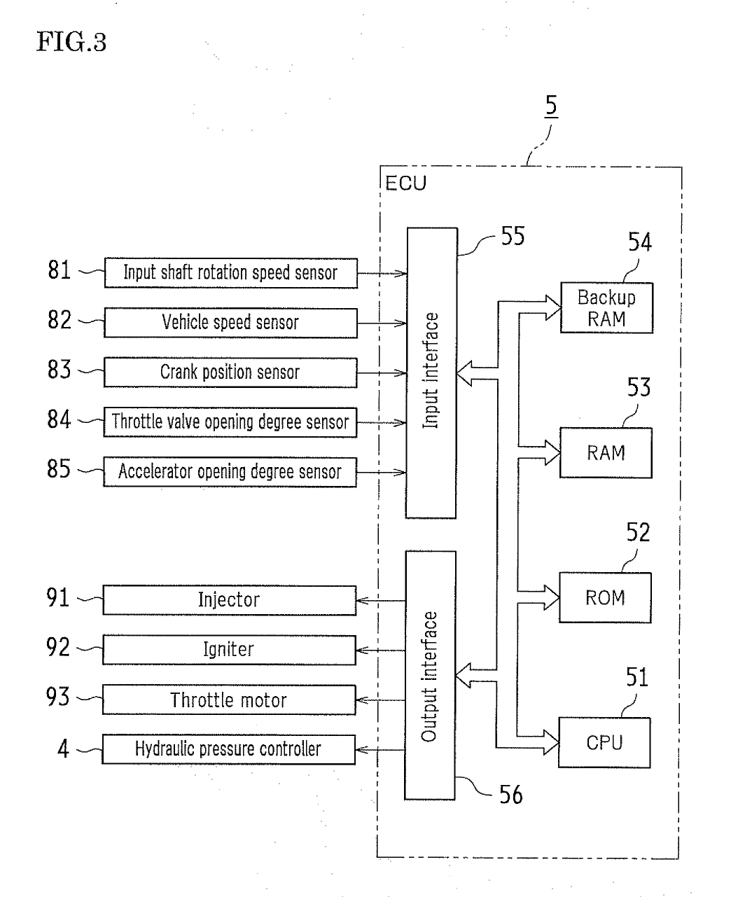

The ECU 5 is configured to execute operation control of the engine 1, shift control of the automatic transmission 3, and the like. Specifically, the ECU 5 includes, as shown in FIG. 3: a CPU 51; a ROM 52; a RAM 53; a backup RAM 54; an input interface 55; and an output interface 56. The ECU 5 is an example of the “automatic transmission controller” of the present invention.

The CPU 51 executes computing processing based on various control programs and maps that are stored in the ROM 52. The ROM 52 stores, for example, the various control programs and the maps to be referred to when executing the various control programs. The RAM 53 is a memory for temporary storing computation results by the CPU 51 and data detected by respective sensors. The backup RAM 54 is a nonvolatile memory for storing data to be stored when the ignition is turned off.

To the input interface 55 are connected an input shaft rotation speed sensor 81, a vehicle speed sensor 82, a crank position sensor 83, a throttle valve opening degree sensor 84, an accelerator opening degree sensor 85, and the like.

The input shaft rotation speed sensor 81 is provided to calculate the rotation speed per unit time of the input shaft of the automatic transmission 3. The vehicle speed sensor 82 is provided to detect the speed of the vehicle 100, and the crank position sensor 83 is provided to calculate the rotation speed per unit time of the engine 1. The throttle valve opening degree sensor 84 is provided to detect the opening degree of the throttle valve, and the accelerator opening degree sensor 85 is provided to detect the accelerator opening degree that is a stepping amount of an accelerator pedal.

To the output interface 56 are connected an injector 91, an igniter 92, a throttle motor 93, a hydraulic pressure controller 4, and the like. The injector 91 is a fuel injection valve that is capable of adjusting a fuel injection amount. The igniter 92 is provided to adjust the ignition timing by a spark plug. The throttle motor 93 is provided to adjust the opening degree of the throttle valve.

The ECU 5 is configured to control the operating state of the engine 1 by controlling the throttle valve opening degree, the fuel injection amount and the ignition timing according to results detected by the various sensors. The ECU 5 is also configured to perform shift control of the automatic transmission 3 and lock-up clutch control of the torque converter 2 by controlling the hydraulic pressure controller 4.

In the shift control by the ECU 5, for example, a target gear stage is set based on a shift map using the vehicle speed and the accelerator opening degree as parameters. Thus, the hydraulic pressure controller 4 is controlled so that the actual gear stage becomes the target gear stage. In this shift control, it is permitted to shift the gear stage to another gear stage that is established by release of one friction engaging element and engagement of one friction engaging element, and it is prohibited to shift the gear stage to another gear stage that requires release of two friction engaging elements and engagement of two friction engaging elements. For example, when the eighth gear stage is being established, it is permitted to shift this gear stage to the second gear stage and the fifth through seventh gear stages while it is prohibited to shift this gear stage to the first gear stage, the third gear stage and the fourth gear stage. Here, the shift of the current gear stage to a gear stage spaced two or more stages apart is referred to “skip shift”.

When the shift is performed by the automatic transmission 3, the ECU 5 is configured to calculate a differential rotation speed of the input shaft before and after shifting (i.e. a difference between the rotation speed per unit time of the input shaft before shifting and that after shifting), and also to calculate a target shift time based on the differential rotation speed of the input shaft and an input torque to the input shaft. When the gear stage is automatically shifted by the input torque at the time of, for example, power-on downshift or power-off upshift (i.e. when the direction in which the rotation speed of the input shaft is changed by the input torque equals the direction in which the rotation speed of the input shaft changes according to the shift), if the target shift time is short relative to the input torque, the target shift time is corrected according to the input torque.

The rotation speed of the input shaft before shifting is calculated, for example, based on the results detected by the input shaft rotation speed sensor 81. The rotation speed of the input shaft after shifting is calculated, for example, based on the gear ratio of the gear stage after shifting and rotation speed of the output shaft. Also, the input torque that is input to the input shaft is calculated, for example, based on the engine torque and the torque ratio of the torque converter 2.

In the case of the skip shift, the ECU 5 is configured to shift the gear stage to an intermediate gear stage between the current gear stage and the target gear stage when the target shift time is not less than a predetermined value. The intermediate gear stage is set to the gear stage closest to the target gear stage among the gear stages to which the current gear stage can be shifted. On the other hand, in the case of the skip shift, the ECU 5 is configured to shift the gear stage directly to the target gear stage when the target shift time is less than the predetermined value.

### —Shift Control—

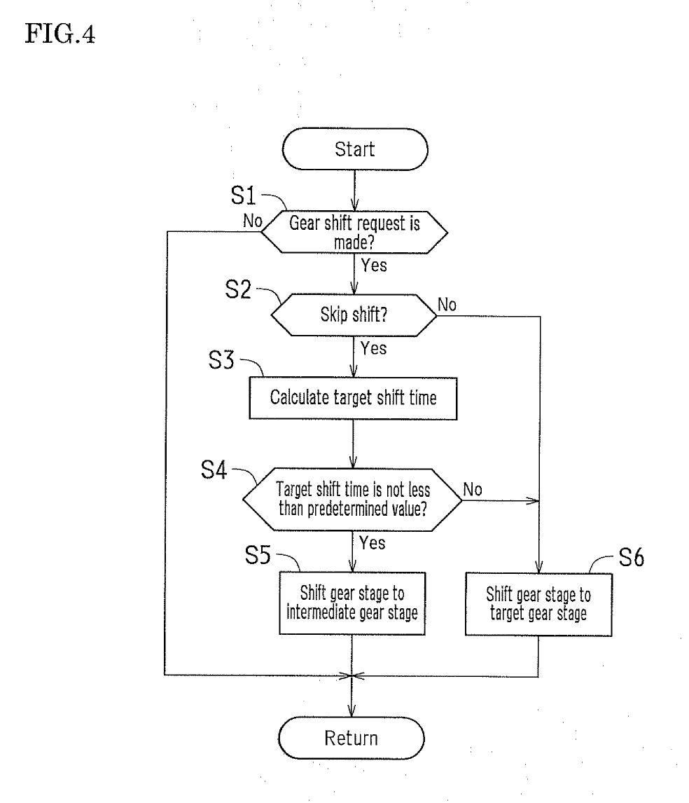

Next, a description will be given on the shift control in the vehicle 100 of this embodiment with reference to FIG. 4. The following flow is repeatedly performed at predetermined time intervals. Each step is executed by the ECU 5.

In step S1, it is determined whether the gear shift request is present or not. Specifically, it is determined that the gear shift request is present when the target gear stage that is set based on the shift map is different from the current gear stage. Also, it is determined that there is no gear shift request when the target gear stage equals the current gear stage. The target gear stage is set to a gear stage that is established, from the current gear stage, by release of one friction engaging element and engagement of one friction engaging element. Then, when it is determined that the gear shift request is present, the procedure advances to step S2. When it is determined that there is no gear shift request, the procedure returns.

Then, in step S2, it is determined whether the requested shift is the skip shift or not. That is, it is determined whether the target gear stage is spaced two or more stages apart from the current gear stage. When it is determined that the requested shift is the skip shift, the procedure advances to step S3. On the other hand, when it is determined that the requested shift is not the skip shift, the procedure advances to step S6 in which the gear stage of the automatic transmission 3 is shifted to the target gear stage (i.e. the gear stage adjacent to the current gear stage) by the hydraulic pressure controller 4, and then the procedure returns.

In step S3, the target shift time is calculated. Specifically, the differential rotation speed of the input shaft before and after shifting is calculated. Thus, the target shift time is calculated based on the differential rotation speed of the input shaft and the input torque to the input shaft. The target shift time may be corrected to a longer time when the input torque is not sufficient due to the low pressure environment of high-altitude or due to response delay of the supercharging pressure in the case where the engine 1 includes a turbocharger.

In step S4, it is determined whether the target shift time is not less than the predetermined value. The predetermined value is set in advance. When it is determined that the target shift time is not less than the predetermined value, the procedure advances to step S5. On the other hand, when it is determined that the target shift time is less than the predetermined value, the procedure advances to step S6 in which the gear stage of the automatic transmission 3 is shifted directly to the target gear stage (i.e. the gear stage spaced two or more stages apart from the current gear stage) by the hydraulic pressure controller 4, and then the procedure returns.

In step S5, the gear stage of the automatic transmission 3 is shifted to the intermediate gear stage by the hydraulic pressure controller 4. The intermediate gear stage is set to the gear stage closest to the target gear stage among the gear stages to which the current gear stage can be shifted. Accordingly, if it is possible to shift the gear stage to a gear stage one stage before the target gear stage, then such a gear stage one stage before the target is set to the intermediate gear stage. After that, the procedure returns.

### [Specific Example of Shift Control]

Next, a specific example of the shift control performed by the ECU 5 will be described.

(Downshift from Eighth Gear Stage to Fifth Gear Stage)

When the downshift is performed from the eighth gear stage as the current gear stage to the fifth gear stage set to the target gear stage, the skip shift is requested as the gear shift request (i.e. steps S1 and S2: Yes). Thus, in step S3, the target shift time is calculated.

Then, when it is determined that the target shift time is less than the predetermined value (i.e. step S4: No), the procedure advances to step S6 in which the gear stage is directly shifted from the eighth gear stage to the fifth gear stage as the target gear stage by the hydraulic pressure controller 4. Specifically, the first brake B1 is released while the first clutch C1 is engaged.

On the other hand, when it is determined that the target shift time is not less than the predetermined value (i.e. step S4: Yes), the procedure advances to step S5 in which the gear stage is shifted from the eighth gear stage to the sixth gear stage as the intermediate gear stage by the hydraulic pressure controller 4. Here, since it is possible to shift the gear stage to the sixth gear stage one stage before the fifth gear stage as the target gear stage, the sixth gear stage is set to the intermediate gear stage. Specifically, the first brake B1 is released while the fourth clutch C4 is engaged.

After that, when the current gear stage is the sixth gear stage and the fifth gear stage is being set to the target gear stage, the gear shift to the adjacent gear stage is requested (i.e. step S1: Yes, and step S2: No). Thus, the procedure advances to step S6 in which the gear stage is shifted from the sixth gear stage to the fifth gear stage as the target gear stage by the hydraulic pressure controller 4. Specifically, the fourth clutch C4 is released and the first clutch C1 is engaged.

(Downshift from Eighth Gear Stage to Second Gear Stage)

When the downshift is performed from the eighth gear stage as the current gear stage to the second gear stage set to the target gear stage, the skip shift is requested as the gear shift request (i.e. steps S1 and S2: Yes). Thus, in step S3, the target shift time is calculated.

Then, when it is determined that the target shift time is less than the predetermined value (i.e. step S4: No), the procedure advances to step S6 in which the gear stage is directly shifted from the eighth gear stage to the second gear stage as the target gear stage by the hydraulic pressure controller 4. Specifically, the second clutch C2 is released while the first clutch C1 is engaged.

On the other hand, when it is determined that the target shift time is not less than the predetermined value (i.e. step S4: Yes), the procedure advances to step S5 in which the gear stage is shifted from the eighth gear stage to the fifth gear stage as the intermediate gear stage by the hydraulic pressure controller 4. Here, it is not possible to shift the gear stage from the eighth gear stage to either the third gear stage one stage before the second gear stage as the target gear stage, or the fourth gear stage two stages before from the second gear stage as the target gear stage. Thus, the intermediate gear stage is set to the fifth gear stage closest to the target gear stage (the second gear stage) among the gear stages to which the current gear stage can be shifted (i.e. the fifth gear stage to the seventh gear stage). Specifically, the first brake B1 is released while the first clutch C1 is engaged.

After that, when the current gear stage is the fifth gear stage and the second gear stage is being set to the target gear stage, the skip shift is requested as the gear shift request (i.e. steps S1 and S2: Yes). Thus, in step S3, the target shift time is calculated.

Then, when it is determined that the target shift time is less than the predetermined value (i.e. step S4: No), the procedure advances to step S6 in which the gear stage is directly shifted from the fifth gear stage to the second gear stage as the target gear stage by the hydraulic pressure controller 4. Specifically, the second clutch C2 is released while the first brake B1 is engaged.

On the other hand, when it is determined that the target shift time is not less than the predetermined value (i.e. step S4: Yes), the procedure advances to step S5 in which the gear stage is shifted from the fifth gear stage to the third gear stage as the intermediate gear stage by the hydraulic pressure controller 4. Here, since it is possible to shift the gear stage to the third gear stage one stage before the second gear stage as the target gear stage, the third gear stage is set to the intermediate gear stage. Specifically, the second clutch C2 is released while the third clutch C3 is engaged.

Further thereafter, when the current gear stage is the third gear stage and the second gear stage is being set to the target gear stage, the gear shift to the adjacent gear stage is requested (i.e. step S1: Yes, and step S2: No). Thus, the procedure advances to step S6 in which the gear stage is shifted from the third gear stage to the second gear stage as the target gear stage by the hydraulic pressure controller 4. Specifically, the third clutch C3 is released and the first brake B1 is engaged.

### —Effects—

In this embodiment as described above, in the case of the skip shift, the gear stage is shifted to the intermediate gear stage between the current gear stage and the target gear stage when the target shift time is not less than the predetermined value. Since the intermediate gear stage can be established in a shorter time than the target shift time, it is possible to improve responsiveness of the driving force. Also in the case of the skip shift, the gear stage is shifted directly to the target gear stage when the target shift time is less than the predetermined value, which prevents the shift shock from occurring. Thus, it is possible to improve responsiveness of the driving force while reducing the occurrence of the shift shock.

Also in this embodiment, since the intermediate gear stage is set to the gear stage closest to the target gear stage among the gear stages to which the current gear stage can be shifted, it is possible to realize the driving force close to a driver's request while improving responsiveness of the driving force.

Also in this embodiment, it is prohibited to shift the gear stage to another gear stage that requires release of two friction engaging elements and engagement of two friction engaging elements. Thus, it is possible to reduce the shift shock.

Furthermore, in this embodiment, the target shift time is calculated based on the differential rotation speed of the input shaft and the input torque. Thus, it is possible to suitably calculate respective target shift times even when the shift pattern is the same.

### OTHER EMBODIMENTS

The embodiment as described above is to be considered in all respects as illustrative and not limiting. Therefore, the technical scope of the invention should not be interpreted only by the foregoing embodiment, but is indicated by the appended claims. All modifications and changes that come within the meaning and range of equivalency of the claims are intended to be embraced in the technical scope of the invention.

For example, in this embodiment, the vehicle 100 is an FF (front engine/front wheel drive) vehicle. However, the present invention is not limited thereto. The vehicle may be an FR (front engine/rear wheel drive) vehicle or may be a 4WD (four wheel drive) vehicle.

Also, in this embodiment, the gear stage is shifted to the intermediate gear stage when, for example, the target shift time is not less than the predetermined value. However, the present invention is not limited thereto. The gear stage may be shifted to the intermediate gear stage when the differential rotation speed of the input shaft before and after shifting is not less than the predetermined value.

Also, in this embodiment, the ECU 5 may be constituted by a plurality of ECUs.

### INDUSTRIAL APPLICABILITY

The present invention may be applied to an automatic transmission controller that controls an automatic transmission to selectively engage a plurality of friction engaging elements and thus to establish multiple gear stages.

### DESCRIPTION OF REFERENCE NUMERALS

3 Automatic transmission
5 ECU (automatic transmission controller)
C1 First clutch (friction engaging element)
C2 Second clutch (friction engaging element)
C3 Third clutch (friction engaging element)
C4 Fourth clutch (friction engaging element)
B1 First brake (friction engaging element)
B2 Second brake (friction engaging element)

1. An automatic transmission controller to be applied to an automatic transmission configured to selectively engage a plurality of friction engaging elements and thus to establish multiple gear stages,
wherein the automatic transmission controller is configured to calculate a target shift time based on an input torque that is input to the automatic transmission when a gear stage is shifted from a current gear stage to a target gear stage spaced two or more stages apart from the current gear stage,
wherein the automatic transmission controller is further configured to: shift the gear stage to an intermediate gear stage between the current gear stage and the target gear stage when the target shift time is not less than a predetermined value; and shift the gear stage directly to the target gear stage when the target shift time is less than the predetermined value,
wherein, when the gear stage is shifted from the current gear stage to the intermediate gear stage in the automatic transmission, it is permitted to shift the gear stage to another gear stage that is established by release of one friction engaging element and engagement of one friction engaging element, and it is prohibited to shift the gear stage to another gear stage that requires release of two friction engaging elements and engagement of two friction engaging elements, and
wherein the intermediate gear stage is set to the gear stage closest to the target gear stage among the gear stages to which the current gear stage is allowed to be shifted.
